(19) United States
(12) Patent Application Publication
(10) Pub. No.: US 2026/0346296 A1
(43) Pub. Date: Nov. 5, 2026

(54) GLUE GUN

(71) Applicant: Black & Decker Inc., New Britain, CT (US)

(72) Inventors: Yin Li, Suzhou (CN); Zhenming Zhu, Suzhou (CN)

(21) Appl. No.: 19/555,499

(22) Filed: Mar. 3, 2026

(30) Foreign Application Priority Data
Mar. 4, 2025 (GB) 2503101.4

(51) Int. Cl. B05C 17/005

(52) U.S. Cl. CPC B05C 17/0053; B05C 17/00546

(57) ABSTRACT

A hot melt glue gun comprises an electric motor, a heating section, and an advancement mechanism. The motor is configured to drive the advancement mechanism to advance a solid thermoplastic adhesive rod along an advancement axis towards the heating section. The advancement mechanism comprises a multi-stage gear transmission comprising a plurality of gears having parallel rotational axes arranged substantially perpendicular to the advancement axis. The motor has a rotational output shaft carrying a gear that is meshed with a first stage gear of the advancement mechanism, and the motor output shaft is parallel to the rotational axes of the gears of the multi-stage gear transmission.

### CROSS-REFERENCE TO RELATED APPLICATION

This application claims priority under 35 U.S.C. § 119 to GB Application GB2503101.4, filed Mar. 4, 2025, titled “GLUE GUN,” which is incorporated herein by reference in its entirety.

### TECHNICAL FIELD

The present invention relates to portable handheld adhesive applicators, i.e. glue guns. The invention particularly relates to hot melt glue guns, i.e. portable handheld adhesive applicators of the type supplied, in use, with a solid thermoplastic adhesive rod (i.e. a “glue stick”) and which melts the adhesive rod to dispense hot melt adhesive, which subsequently resolidifies upon cooling. The invention seeks to provide an improved hot melt glue gun.

### SUMMARY

Accordingly, a first aspect of the disclosure provides a hot melt glue gun, comprising an electric motor, a heating section, and an advancement mechanism, wherein the motor is configured to drive the advancement mechanism to advance a solid thermoplastic adhesive rod along an advancement axis towards the heating section, wherein the advancement mechanism comprises a multi-stage gear transmission comprising a plurality of gears having parallel rotational axes arranged substantially perpendicular to the advancement axis, wherein the motor has a rotational output shaft carrying a gear that is meshed with a first stage gear of the advancement mechanism, and wherein the motor output shaft is parallel to the rotational axes of the gears of the multi-stage gear transmission.

A second aspect of the disclosure provides a hot melt glue gun, comprising a housing, a heating section, an advancement mechanism, and an output nozzle, the housing supporting the heating section, the advancement mechanism, and the output nozzle, wherein the housing carries an extendable and retractable drip tray, and wherein the drip tray is configured to be both translatable and rotatable with respect to the housing to enable the drip tray to be moved with respect to the housing between its extended and retracted positions.

It is explicitly to be understood that any feature or embodiment, including any preferred or other optional feature or embodiment, of any aspect or embodiment of the disclosure or the invention, may be a feature or embodiment, including a preferred or other optional feature or embodiment, of any other aspect or embodiment of the disclosure or the invention.

The advancement mechanism of the glue gun may include one or more, preferably a plurality of, rotary advancement member(s) arranged to contact a said adhesive rod and advance it towards the heating section by rotation of the advancement member(s) by the gear transmission driven by the motor. Preferably, the, or each, rotary advancement member comprises a gear, a splined member, a wheel, or a roller.

The, or each, rotary advancement member preferably is carried by a gear shaft of the multi-stage gear transmission of the advancement mechanism. More preferably, the, or each, rotary advancement member is carried by a gear shaft of a final stage gear of the multi-stage gear transmission of the advancement mechanism.

Advantageously, the, or each, rotary advancement member may be located on a region of its gear shaft which extends beyond a first side of the multi-stage gear transmission, thereby providing clearance between the adhesive rod and the multi-stage gear transmission, in use. Preferably, the electric motor is located beyond a second side of the multi-stage gear transmission, opposite to the first side.

In preferred embodiments, a plurality of the gears of the multi-stage transmission of the glue gun each comprises a relatively large diameter gear wheel and a relatively small diameter pinion located on the same gear shaft and having the same rotational axis. Preferably, each gear wheel comprises an nth stage gear wheel, and each pinion located on the same gear shaft and having the same rotational axis as the nth stage gear wheel comprises an (n+1)th stage pinion. Preferably, each of a plurality of (n+1)th stage pinions is meshed with a respective (n+1)th stage gear wheel.

Advantageously, the output shaft of the motor of the glue gun may be substantially surrounded by the plurality of gears of the multi-stage gear transmission, when viewed in a direction along the motor output shaft. Preferably, the motor output shaft is spaced from a periphery of the plurality of gears of the multi-stage gear transmission, when viewed in a direction along the motor output shaft. More preferably, the motor output shaft is generally in the middle of the plurality of gears of the multi-stage gear transmission, when viewed in a direction along the motor output shaft. In at least some preferred embodiments, the plurality of gears of the multi-stage gear transmission of the glue gun have a serpentine arrangement, when viewed in a direction along the motor output shaft. This provides a particularly compact arrangement.

At least one stage of the multi-stage gear transmission may comprise a pair of meshed gear wheels having the same diameter such that both gear wheels rotate at the same speed during use. Preferably, each gear wheel of the pair of meshed gear wheels causes a respective rotary advancement member to rotate in use, such that a pair of the rotary advancement members rotate at the same speed but in opposite directions, during use.

Advantageously, the multi-stage gear transmission may comprise a rotational speed reduction transmission, configured to reduce the rotational speed from the motor output shaft to the rotary advancement member(s). Preferably, each stage of the multi-stage gear transmission provides a rotational speed reduction of at least 2:1. Additionally or alternatively, the overall rotational speed reduction between the motor output shaft and the rotary advancement member(s) is at least 100:1, preferably at least 200:1, more preferably at least 300:1, more preferably at least 400:1, more preferably at least 500:1, especially preferably at least 600:1.

Preferably, the multi-stage gear transmission comprises at least four rotational speed reduction stages, more preferably at least five rotational speed reduction stages, more preferably at least six rotational speed reduction stages.

The hot melt glue gun advantageously may comprise a glue gun housing supporting and at least partly containing the electric motor, the heating section, and the advancement mechanism. Preferably, the motor extends at least partly into a handle portion of the glue gun housing. The handle portion preferably includes a user-actuatable trigger for actuating the electric motor and thereby actuating the advancement mechanism.

For embodiments of the invention in which the motor is located beyond a second side of the multi-stage gear transmission (opposite to the first side beyond which the rotary advancement members extend), and preferably also in which the output shaft of the motor is substantially surrounded by the plurality of gears of the multi-stage gear transmission (when viewed in a direction along the motor output shaft), this particularly enables the possibility of the motor extending at least partly into a handle portion of the glue gun housing, e.g. with the motor axis generally or approximately parallel to the axis of the handle. This arrangement is especially compact, and enables the motor and the advancement mechanism to be fitted into a relatively compact housing of the handheld glue gun, thereby enabling the glue gun to be compact and more easily held and manipulated by the user, in one hand.

Preferably, the hot melt glue gun further comprises a transmission housing at least partly contained within the glue gun housing, wherein the multi-stage gear transmission is contained within the transmission housing.

The heating section of the hot melt glue gun preferably comprises a heating chamber configured to receive and melt an adhesive rod therein.

The hot melt glue gun preferably further comprises a nozzle located adjacent to the heating section, configured to output hot melt glue therefrom, during use.

Advantageously, the hot melt glue gun may further comprise a battery pack receptacle configured to removably receive a battery pack for powering the electric motor and the heating section.

Regarding the above-mentioned second aspect, the disclosure provides a hot melt glue gun, comprising a housing, a heating section, an advancement mechanism, and an output nozzle, the housing supporting the heating section, the advancement mechanism, and the output nozzle, wherein the housing carries an extendable and retractable drip tray, and wherein the drip tray is configured to be both translatable and rotatable with respect to the housing to enable the drip tray to be moved with respect to the housing between its extended and retracted positions.

In preferred embodiments, the drip tray is mounted on a carrier which is supported by the housing. Preferably the carrier is elongate.

Advantageously, the drip tray may be rotatable with respect to the carrier, thereby to rotate the drip tray with respect to the housing. Preferably, the carrier includes an opening in which the drip tray is rotatably receivable, and from which the drip tray is rotatably extendable.

The housing of the glue gun may include a recess or slot, and at least part of the carrier may be slidably received in the recess or slot such that the carrier is translatable with respect to the housing, thereby to translate the drip tray with respect to the housing. Preferably, the recess or slot in the housing (where present) is located below the heating section.

The drip tray preferably is extendable to a position below the output nozzle, thereby to catch drips of molten glue therefrom. Preferably, the drip tray is retractable to a position set back from the output nozzle. Advantageously, the drip tray may be retractable to a position below the heating section.

In some preferred embodiments, the drip tray is translatable and rotatable in any order. For example, in such preferred embodiments, the user may slide out the drip tray and then rotate it further out, or the user may rotate the drip tray and then slide it out. Or perhaps the user may rotate and slide the drip tray simultaneously, for example.

The drip tray preferably comprises a shallow receptacle for catching drips of molten glue. Preferably, at least a portion of the drip tray comprises substantially flat surface for catching drips of molten glue. For example, the drip tray may comprise a shallow receptacle with a substantially flat bottom surface.

Preferably, the drip tray includes one or more projecting tabs to facilitate manipulation of the drip tray be the user.

The carrier preferably includes one or more retainers for slidably retaining the carrier in the recess or slot. The, or each, retainer may comprise a projection configured to engage a retaining projection in the recess or slot, for example.

The details of one or more implementations are set forth in the accompanying drawings and the description below. Other features will be apparent from the description and drawings, and from the claims.

### BRIEF DESCRIPTION OF THE DRAWINGS

FIG. 1 shows a cross-sectional perspective view of an embodiment of a hot melt glue gun according to the disclosure;

FIG. 2 shows a cross-sectional view of another embodiment of a hot melt glue gun according to the disclosure;

FIG. 3A shows a cross-sectional view of another embodiment of a hot melt glue gun according to the disclosure;

FIG. 3B shows a view of a transmission housing and motor of another embodiment of a hot melt glue gun according to the disclosure;

FIG. 4A shows a detailed view of an exposed transmission of an embodiment of a hot melt glue gun according to the disclosure;

FIG. 4B shows another detailed view of the exposed transmission of the FIG. 4A embodiment of a hot melt glue gun according to the disclosure;

FIG. 4C shows a plan view of the motor of the FIG. 4A embodiment of a hot melt glue gun according to the disclosure;

FIG. 5A shows another detailed view of the exposed transmission of the FIG. 4A embodiment of a hot melt glue gun according to the disclosure;

FIG. 5B shows another detailed view of the exposed transmission of the FIG. 4A embodiment of a hot melt glue gun according to the disclosure;

FIG. 6 shows a perspective plan view of a transmission similar to that shown in FIGS. 4A-4C and 5A-5B, contained in a bottom part of a transmission housing;

FIG. 7 shows a side view of an exposed transmission similar to that shown in FIGS. 4A-4C, 5A-5B, and 6;

FIG. 8 shows a detailed view of an exposed transmission of another embodiment of a hot melt glue gun according to the disclosure;

FIG. 9A shows another detailed view of the exposed transmission of the FIG. 8 embodiment of a hot melt glue gun according to the disclosure;

FIG. 9B shows a plan view of the motor of the FIG. 8 embodiment of a hot melt glue gun according to the disclosure;

FIG. 10 shows a perspective view of the transmission of FIG. 8, contained in a bottom part of a transmission housing;

FIG. 11 shows the heating section and output nozzle of an embodiment of a hot melt glue gun according to the disclosure;

FIGS. 12A and 12B are partial cross-sectional views (view 12A is also a perspective view) of an embodiment of a hot melt glue gun according to the disclosure;

FIGS. 13A, 13B, 13C, and 13D are perspective sequential views of an embodiment of a hot melt glue gun according to the disclosure, showing an extendable and retractable drip tray being rotated and translated to move it from its retracted position to its extended position;

FIGS. 14A, 14B, 14C, and 14D are cross-sectional sequential views corresponding to the perspective view of FIG. 12A, of an embodiment of a hot melt glue gun according to the disclosure, showing an extendable and retractable drip tray being rotated and translated to move it from its retracted position to its extended position;

FIG. 15A is a perspective view of the drip tray and carrier of the embodiment of FIGS. 12A and 12B and FIGS. 13A-13D, showing the drip tray received in an opening in the carrier; and

FIG. 15B is another perspective view of the drip tray and carrier of the embodiment of FIGS. 12A and 12B and FIGS. 13A-13D, showing the drip tray rotated out of the opening in the carrier.

The same or similar parts have the same reference numerals, for simplicity.

### DETAILED DESCRIPTION

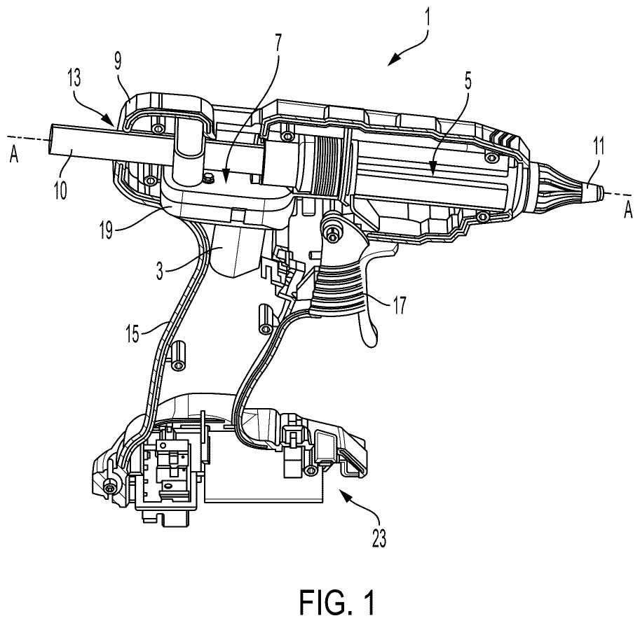

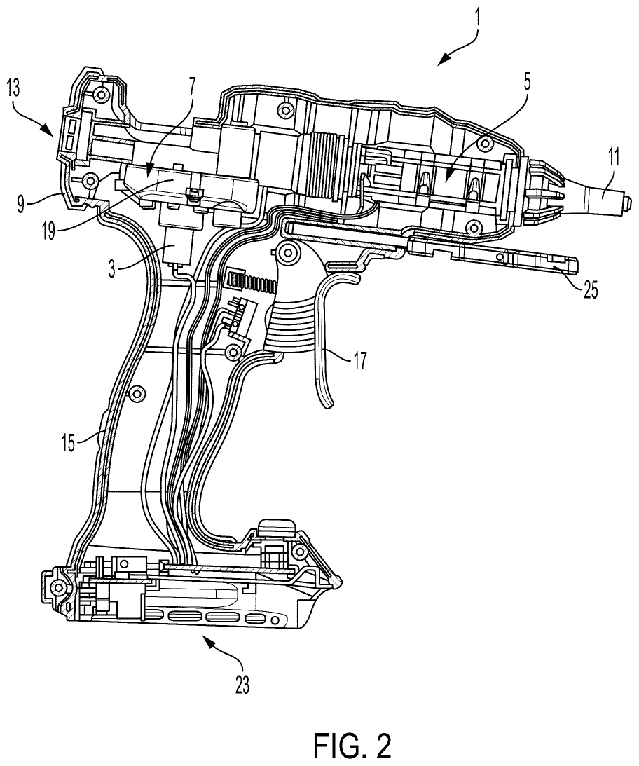

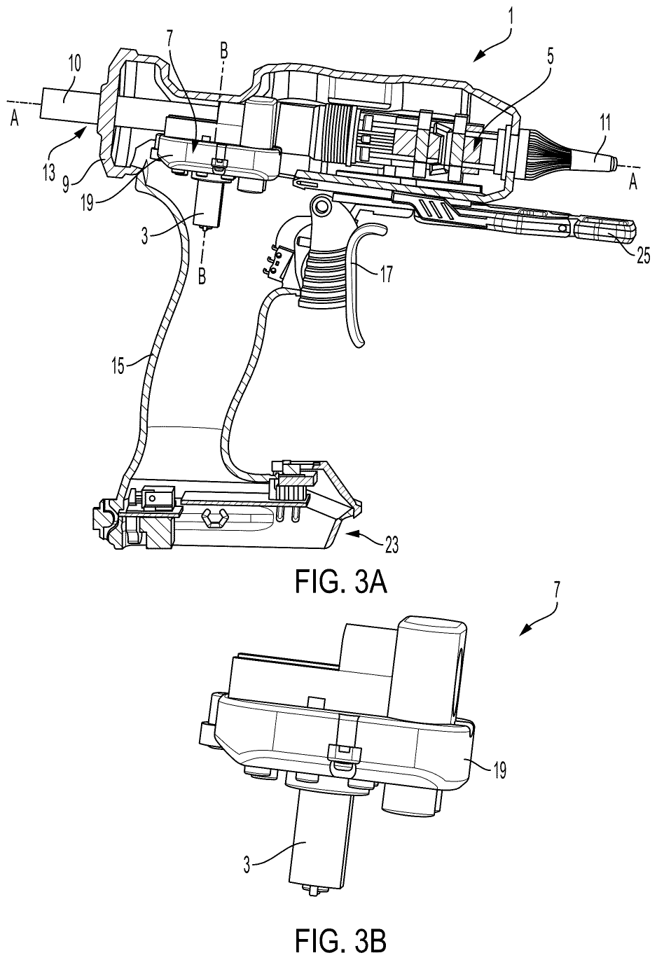

FIG. 1 shows a cross-sectional perspective view of an embodiment of a hot melt glue gun 1 according to the disclosure, and FIGS. 2 and 3(a) show cross-sectional views of similar embodiments of hot melt glue gun 1 according to the disclosure. Each hot melt glue gun 1 comprises an electric motor 3, a heating section 5, and an advancement mechanism 7. Each hot melt glue gun 1 also comprises a housing 9 and an output nozzle 11 at the front of the housing. The housing 9 supports and contains the motor 3, the heating section 5, and the advancement mechanism 7, and the housing 9 also supports and at least partially contains the output nozzle 11.

The motor 3 is configured to drive the advancement mechanism 7 to advance a solid thermoplastic adhesive rod 10, which is inserted into a rear opening 13 of the glue gun housing 9 in use, along an advancement axis A-A forwards towards the heating section 5 and the output nozzle 11. The motor 3 extends at least partly into a handle portion 15 of the glue gun housing 9. The handle portion 15 includes a user-actuatable trigger 17 for actuating the electric motor 3 and thereby actuating the advancement mechanism 7. The glue gun housing 9 also contains a transmission housing 19 which contains the advancement mechanism 7 comprising a multi-stage gear transmission 21. The combined transmission housing 19 and motor 3 are also shown separately in FIG. 3(b).

As also shown in FIGS. 1, 2, and 3(a), the hot melt glue gun 1 embodiments also include a battery pack receptacle 23 configured to removably receive a battery pack for powering the electric motor 3 and the heating section 5. The battery pack receptacle 23 is located at the foot of the handle portion 15 of the glue gun housing 9.

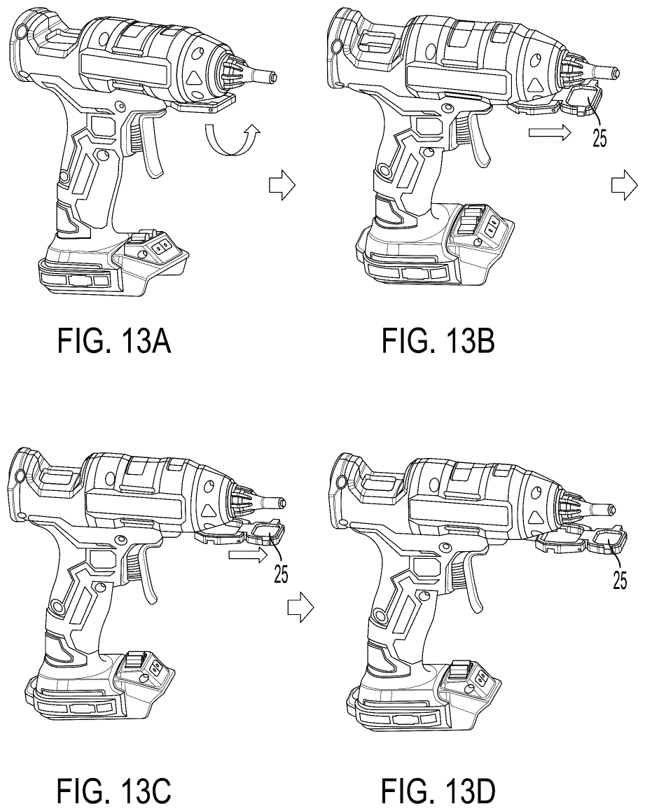

In the embodiments shown in FIGS. 2 and 3, the glue gun housing 9 also carries an extendable and retractable drip tray 25. As described in detail below, with reference to FIGS. 13 to 15, the drip tray 25 is configured to be both translatable and rotatable with respect to the housing 9 to enable the drip tray 25 to be moved with respect to the housing 9 between its extended and retracted positions.

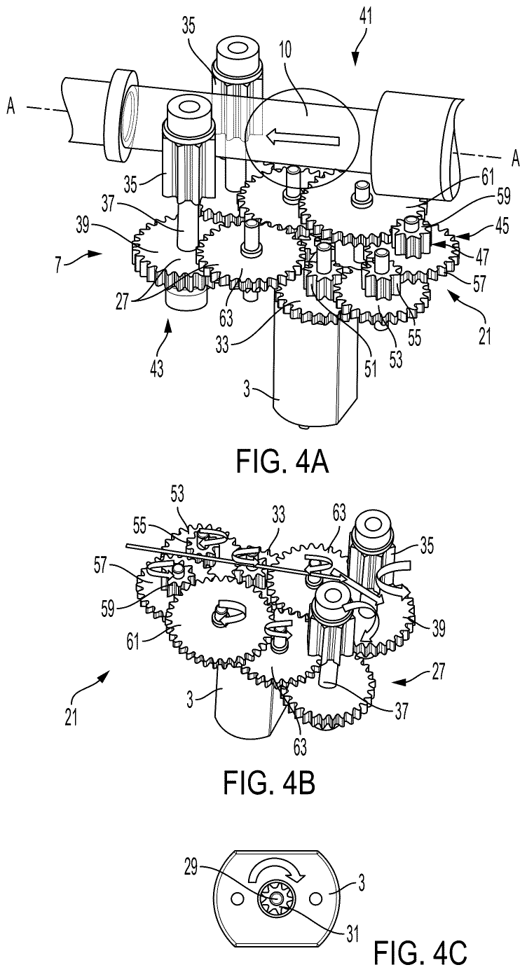

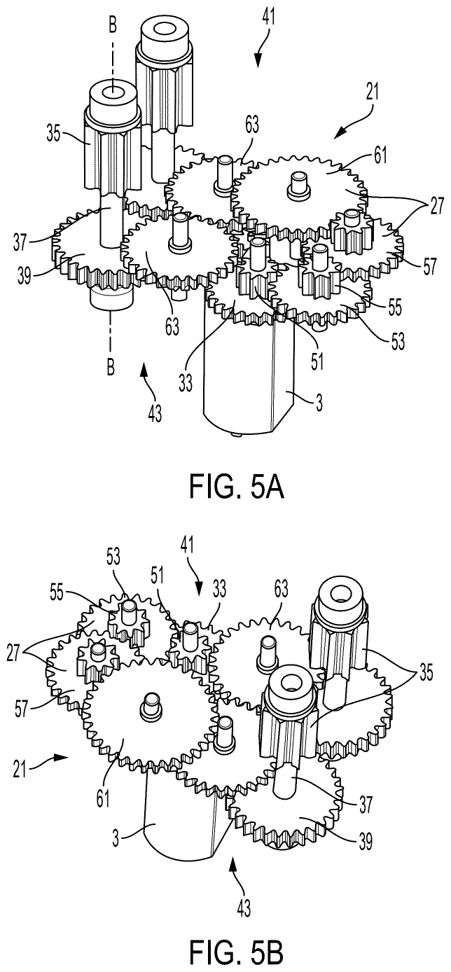

Referring now to FIGS. 4 and 5, FIG. 4(a) shows a detailed view of an advancement mechanism 7 comprising multi-stage gear transmission 21, and a motor 3, of an embodiment of a hot melt glue gun 1 according to the disclosure. FIG. 4(b) shows another detailed view of the transmission 21 of FIG. 4(a) from a different perspective, and FIG. 4(c) shows a plan view of the motor of the FIG. 4(a) embodiment. FIG. 5(a) and 5(b) show additional similar detailed views of the transmission 21 of FIG. 4(a).

The advancement mechanism 7 shown in FIGS. 4 and 5 comprises a multi-stage gear transmission 21 comprising a plurality of gears 27 having parallel rotational axes B-B arranged substantially perpendicular to the advancement axis A-A. The motor 3 has a rotational output shaft 29 carrying a pinion gear 31 that is meshed with a first stage gear 33 of the advancement mechanism 7. The motor output shaft 29 is parallel to the rotational axes B-B of the gears 27 of the multi-stage gear transmission 21.

The advancement mechanism 7 shown in FIGS. 4 and 5 also includes a pair of rotary advancement members 35 arranged to contact an adhesive rod 10 and advance it towards the heating section 5 by rotation of the advancement members 35 by the gear transmission 21 driven by the motor 3. Each rotary advancement member 35 may comprise a gear, a splined member, a wheel, or a roller, for example. In the illustrated embodiment, the rotary advancement members 35 comprise gears or splined members.

Each rotary advancement member 35 is carried by a gear shaft 37 of the multi-stage gear transmission 21 of the advancement mechanism 7, and in particular is carried by a gear shaft 37 of a final stage gear 39 of the multi-stage gear transmission 21. Additionally, each rotary advancement member 35 is located on a region of its gear shaft 37 which extends beyond a first side 41 of the multi-stage gear transmission 21, thereby providing clearance between the adhesive rod 10 and the multi-stage gear transmission 21, in use. The electric motor 3 is located beyond a second side 43 of the multi-stage gear transmission 21, opposite to the first side 41.

As illustrated, a plurality of the gears 27 of the multi-stage transmission 21 of the glue gun 1 each comprises a relatively large diameter gear wheel 45 and a relatively small diameter pinion 47 located on the same gear shaft 37 and having the same rotational axis B-B. Each gear wheel 45 may be regarded as comprising an nth stage gear wheel 45, and each pinion 47 located on the same gear shaft 37 and having the same rotational axis B-B as the nth stage gear wheel 45 comprises an (n+1)th stage pinion 47. Each one of a plurality of (n+1)th stage pinions 47 is meshed with a respective (n+1)th stage gear wheel 45.

As can be seen in FIGS. 4 and 5, the output shaft 29 of the motor 3 of the glue gun 1 embodiment is substantially surrounded by the plurality of gears 27 of the multi-stage gear transmission 21, when viewed in a direction along the motor output shaft 29. Thus, the motor output shaft 29 is spaced from a periphery of the plurality of gears 27 of the multi-stage gear transmission 21, when viewed in a direction along the motor output shaft 29. Indeed, the motor output shaft 29 is generally in the middle of the plurality of gears 27 of the multi-stage gear transmission 21, when viewed in a direction along the motor output shaft 29. In particular, the plurality of gears 27 of the multi-stage gear transmission 21 of the glue gun 1 may be considered to have a generally serpentine arrangement, following the route of the gear speed reduction stages, when viewed in a direction along the motor output shaft 29. This provides a particularly compact arrangement.

As explained above, for such embodiments of the invention in which the motor 3 is located beyond a second side 43 of the multi-stage gear transmission 21 (opposite to the first side 41 beyond which the rotary advancement members extend), and preferably also in which the output shaft 29 of the motor 3 is substantially surrounded by the plurality of gears 27 of the multi-stage gear transmission 21 (when viewed in a direction along the motor output shaft 29), this particularly enables the possibility of the motor 3 extending at least partly into the handle portion 15 of the glue gun housing 9, e.g. with the motor axis generally or approximately parallel to the axis of the handle. This arrangement is especially compact, and enables the motor 3 and the advancement mechanism 7 to be fitted into a relatively compact housing 9 of the handheld glue gun 1, thereby enabling the glue gun 1 to be compact and more easily held and manipulated by the user, in one hand.

The example embodiment illustrated in FIGS. 4 and 5 comprises a six-stage transmission. The curved arrows in FIG. 4(b) and 4(c) indicate directions of rotation. The first stage comprises the meshing between the motor pinion 31 and the first stage gear wheel 33. The second stage comprises the meshing between the second stage pinion 51 and the second stage gear wheel 53. The third stage comprises the meshing between the third stage pinion 55 and the third stage gear wheel 57. The fourth stage comprises the meshing between the fourth stage pinion 59 and the fourth stage gear wheel 61. The fifth stage comprises the meshing between a fifth stage pinion (hidden below the fourth stage gear wheel, in the figures) and one of two identical fifth stage gear wheels 63. The two fifth stage gear wheels 63 are meshed together and therefore rotate in opposite directions to each other, as indicated by the arrows in FIG. 4(b), and at the same speed as each other because they have the same diameter. The sixth and final stage comprises the meshing between each one of two sixth stage pinions (hidden below the fifth stage gear wheels 63, in the figures) and a respective one of two identical sixth and final stage gear wheels 39, which also rotate in opposite directions to each other, as indicated by the arrows in FIG. 4(b), and at the same speed because they have the same diameter.

The gear shaft 37 of each sixth and final stage gear wheel 39 also carries a respective rotary advancement member 35. Consequently, the two rotary advancement members 35 rotate in opposite directions to each other, as indicated by the arrows in FIG. 4(b), and at the same speed, because the two sixth and final stage gear wheels 39 rotate in opposite directions to each other and at the same speed. In this way, the two rotary advancement members 35 are able to advance a solid adhesive rod 10 along axis A-A towards the heating section 5 when the multi-stage gear transmission 21 is powered by the motor 3 in use, as shown in FIG. 4(a).

As indicated above, the multi-stage gear transmission 21 of the above illustrated example embodiment of FIGS. 4 and 5 comprises a rotational speed reduction transmission, configured to reduce the rotational speed from the motor output shaft 29 to the rotary advancement members 35. The gear speed reduction ratios for each of the above-described gear stages are as follows: stage 1=25/8; stage 2=25/9; stage 3=25/9; stage 4=34/9; stage 5=29/12; stage 6=29/10. In this illustrated example embodiment, the overall speed reduction between the motor output shaft 29 and the rotary advancement members 35 is therefore 638.4/1.

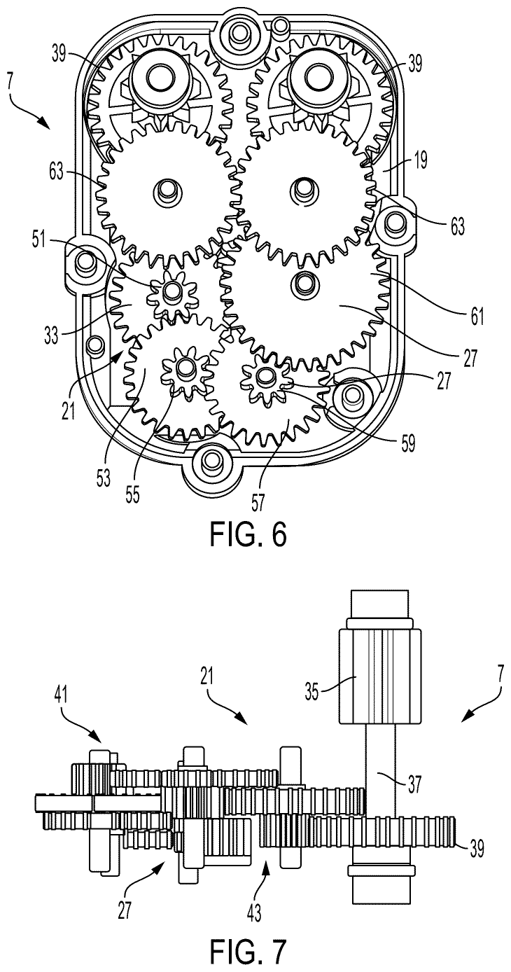

FIG. 6 shows a perspective plan view of a multi-stage gear transmission 21 similar to that shown in FIGS. 4 and 5, contained in a bottom part of a transmission housing 19. FIG. 7 shows a side view of an isolated multi-stage gear transmission 21 similar to that shown in FIGS. 4, 5 and 6.

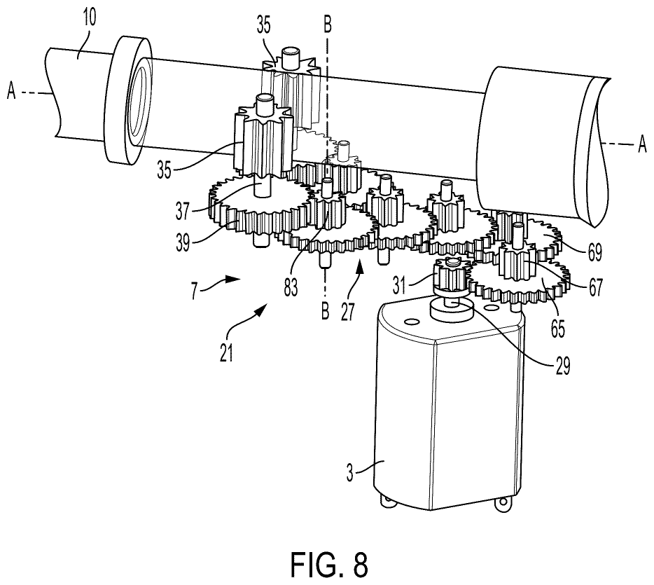

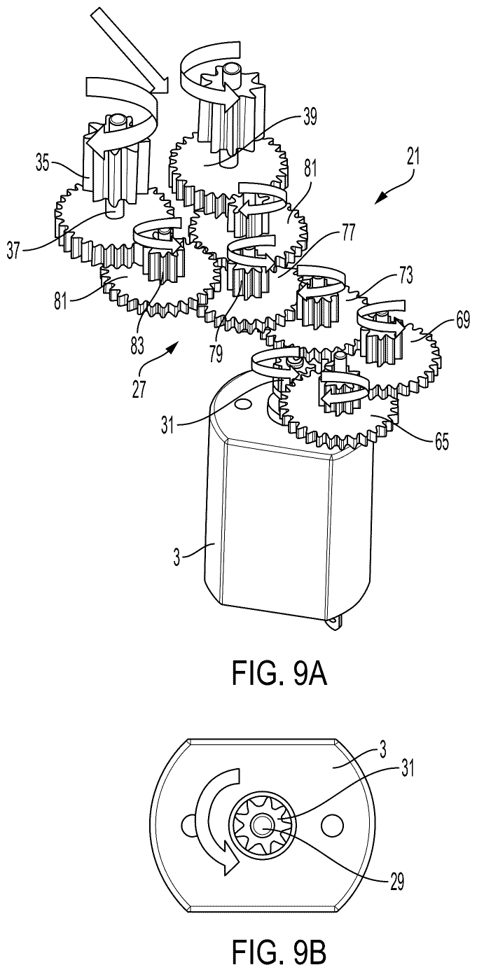

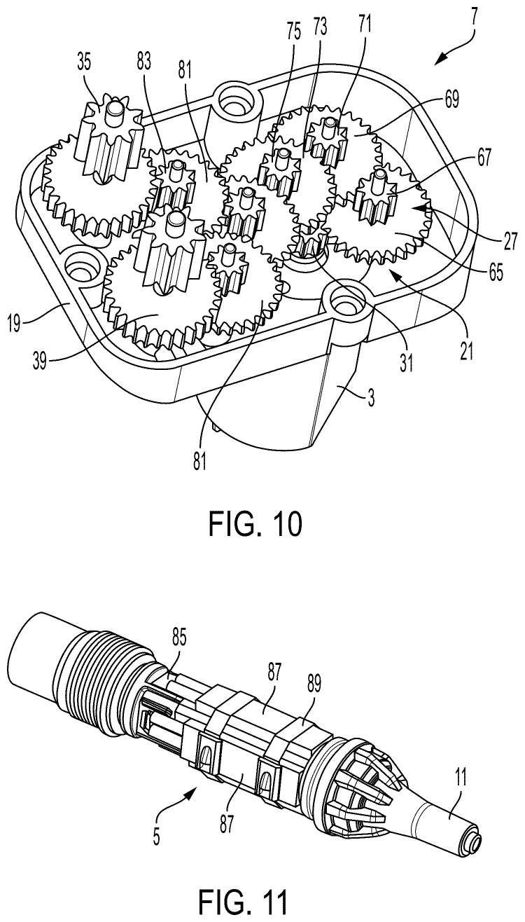

FIG. 8 shows a detailed view of an exposed (isolated) multi-stage gear transmission 21 of another embodiment of a hot melt glue gun according to the disclosure. FIG. 9(a) shows another detailed view of the exposed transmission of the FIG. 8 embodiment of a hot melt glue gun according to the disclosure, and FIG. 9(b) shows a plan view of the electric motor 3 of the FIG. 8 embodiment of a hot melt glue gun 1 according to the disclosure. FIG. 10 shows a perspective view of the transmission of FIG. 8, contained in a bottom part of a transmission housing 19.

The version of a multi-stage gear transmission 21 shown in FIGS. 8 to 10 is another six-stage transmission, but modified from that shown in FIGS. 4 and 5. The curved arrows in FIG. 9(a) and 9(b) indicate directions of rotation. The first stage comprises the meshing between the motor pinion 31 and the first stage gear wheel 65. The second stage comprises the meshing between the second stage pinion 67 and the second stage gear wheel 69. The third stage comprises the meshing between the third stage pinion 71 and the third stage gear wheel 73. The fourth stage comprises the meshing between the fourth stage pinion 75 and the fourth stage gear wheel 77. The fifth stage comprises the meshing between a fifth stage pinion 79 and one of two identical fifth stage gear wheels 81. The two fifth stage gear wheels 81 are meshed together and therefore rotate in opposite directions to each other, as indicated by the arrows in FIG. 9(a), and at the same speed as each other because they have the same diameter. The sixth and final stage comprises the meshing between each one of two sixth stage pinions 83 and a respective one of two identical sixth and final stage gear wheels 39, which also rotate in opposite directions to each other, as indicated by the arrows in FIG. 9(a), and at the same speed because they have the same diameter.

The gear shaft 37 of each sixth and final stage gear wheel 39 also carries a respective rotary advancement member 35. Consequently, the two rotary advancement members 35 rotate in opposite directions to each other, as indicated by the arrows in FIG. 9(a), and at the same speed, because the two sixth and final stage gear wheels 39 rotate in opposite directions to each other and at the same speed. In this way, the two rotary advancement members 35 are able to advance a solid adhesive rod 10 along axis A-A towards the heating section 5 when the multi-stage gear transmission 21 is powered by the motor 3 in use, as shown in FIG. 8.

FIG. 11 shows the heating section 5 and output nozzle 11 of an example embodiment of a hot melt glue gun 1 according to the disclosure. The heating section 5 of the example embodiment hot melt glue gun 1 comprises an aluminium heating chamber 85 configured to receive and melt an adhesive rod 10 therein. The exterior of the heating chamber 85 has a plurality of PTC (positive temperature coefficient) heating elements 87 strapped to it by means of metal straps 89. The heating section 5 also includes an NTC (negative temperature coefficient) thermistor functioning as a temperature sensor.

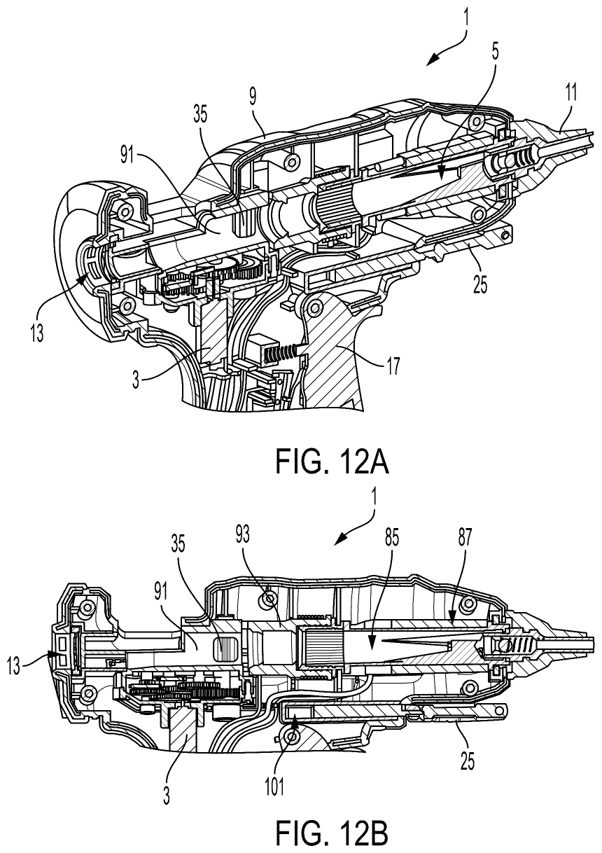

FIG. 12 views (a) and (b) are partial cross-sectional views (view (a) is also a perspective view) of an embodiment of a hot melt glue gun 1 according to the disclosure. Both views show in detail the electric motor 3, the advancement mechanism 7, the heating section 5, and the output nozzle 11. The advancement mechanism 7 comprises the multi-stage gear transmission 21 in the transmission housing 19, and includes the rotary advancement members 35. The rotary advancement members 35 partially extend into a longitudinal passage 91 in the transmission housing 19, in which an adhesive rod 10 is inserted in use, thereby to engage and advance the adhesive rod 10 towards the heating section 5. An elastomeric tubular section 93 bridges a space between the transmission housing 19 and the heating section 5. The heating section 5 comprises the heating chamber 85 and PTC heating elements 87 on the exterior thereof.

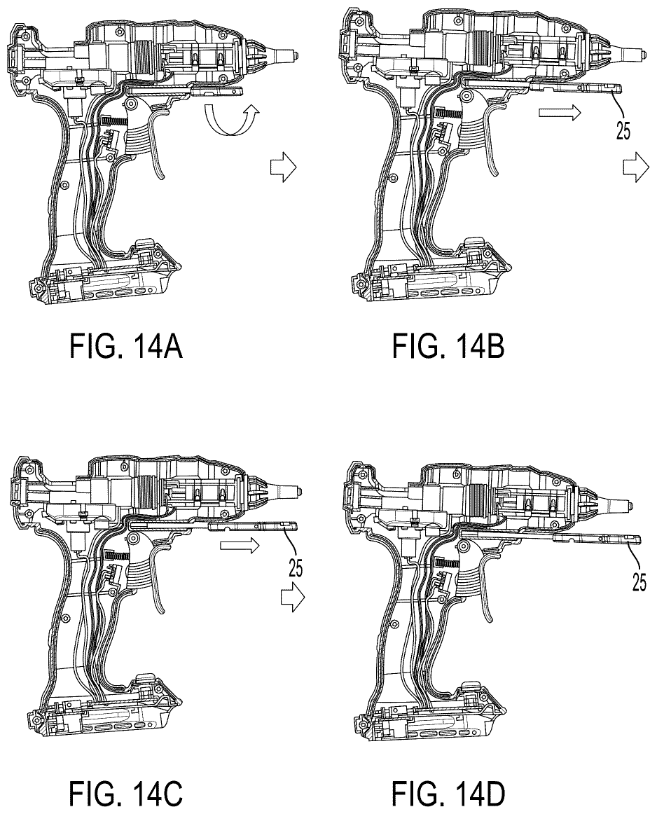

As described above, in at least some embodiments, the glue gun housing 9 carries an extendable and retractable drip tray 25. FIG. 13 views (a) to (d) are perspective sequential views of an embodiment of a hot melt glue gun 1 according to the disclosure, showing an extendable and retractable drip tray 25 being rotated and translated to move it from its retracted position to its extended position. FIG. 14 views (a) to (d) are cross-sectional sequential views corresponding to the perspective views of FIG. 13. The views of FIG. 12 also show the drip tray 25 in its retracted position.

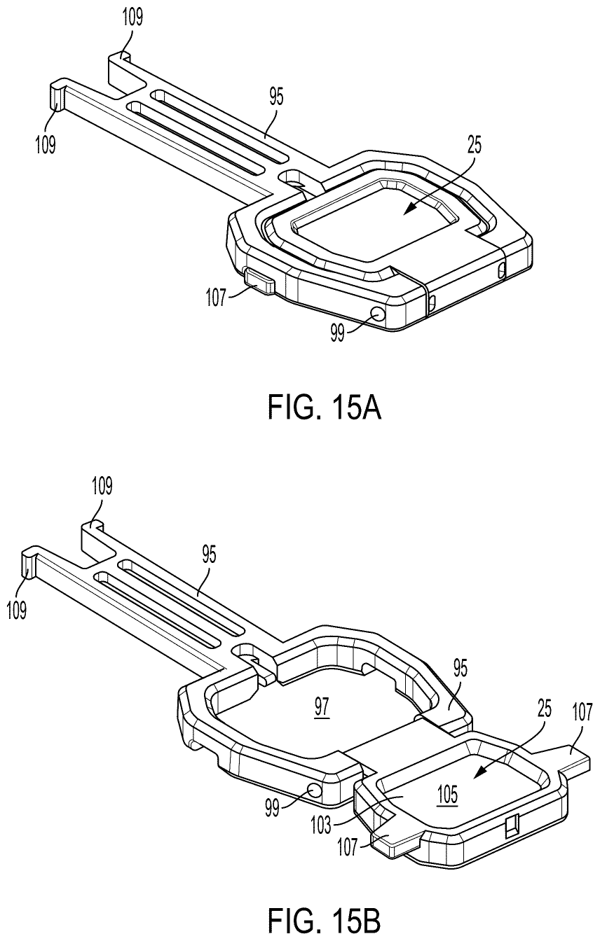

As shown most clearly in FIG. 15(a) and 15(b), the drip tray 25 is advantageously rotatably mounted, e.g. by means of pivots or hinges 99, on an elongate carrier 95 which is supported by the housing 9. FIG. 15(a) is a perspective view of the drip tray 25 and carrier 95 of the embodiment of FIGS. 13 and 14, showing the drip tray 25 received in an opening 97 in the carrier 95. FIG. 15(b) is another perspective view of the drip tray 25 and carrier 95 of the embodiment of FIGS. 13 and 14, showing the drip tray 25 rotated out of the opening 97 in the carrier 95.

As shown in the sequential views of FIGS. 13 and 14, and as indicated by the arrows in those figures, the drip tray 25 is configured to be both translatable and rotatable with respect to the glue gun housing 9 to enable the drip tray 25 to be moved with respect to the housing 9 between its extended and retracted positions. The housing 9 of the glue gun 1 advantageously includes a recess or slot 101, and at least part of the carrier 95 is slidably received in the recess or slot 101 such that the carrier 95 is translatable with respect to the glue gun housing 9, thereby to translate the drip tray 25 with respect to the housing 9. The recess or slot 101 in the housing 9 is located below the heating section 5. The drip tray 25 is extendable to a position below the output nozzle 11, thereby to catch drips of molten glue therefrom. The drip tray 25 is also retractable to a position set back from the output nozzle 11, to a position generally below the heating section 5.

In FIG. 13(a) and 14(a), the drip tray 25 is fully retracted, and the glue gun 1 may be used to apply molten adhesive to a workpiece or other substrate. The curved arrow indicates that the drip tray may be rotated out of its fully retracted position. In FIG. 13(b) and 14(b), and then in FIG. 13(c) and 14(c), the drip tray 25 has been rotated out of its fully retracted position, and is being translated towards its fully extended position, as indicated by the straight arrows. In FIG. 13(d) and 14(d), the drip tray is shown in its fully extended position, below the output nozzle 11, ready to catch drips of molten glue after the use of the glue gun 1 to apply molten adhesive.

In at least some preferred embodiments, the drip tray 25 is translatable and rotatable in any order. For example, in such preferred embodiments, the user may slide out the drip tray 25 and then rotate it further out, or the user may rotate the drip tray 25 and then slide it out. Or perhaps the user may rotate and slide the drip tray simultaneously, for example.

As shown in the views of FIG. 15, the drip tray advantageously comprises a shallow receptacle 103 for catching drips of molten glue. As shown, at least a portion of the drip tray 25 comprises substantially flat surface 105 for catching the drips of molten glue; i.e. the drip tray 25 comprises a shallow receptacle 103 with a substantially flat bottom surface 105. Additionally, the illustrated embodiment of the drip tray 25 includes a pair of projecting tabs 107 to facilitate manipulation of the drip tray 25 by the user. As also shown, the illustrated carrier 95 includes a pair of retainers 109 for slidably retaining the carrier 95 in the recess or slot 101. Each retainer 109 comprises a projection configured to engage a corresponding retaining projection in the recess or slot.

It is to be understood that the described and illustrated embodiments and implementations of the invention and the disclosure are examples, and that other embodiments and implementations fall within the scope of the disclosure and the claimed invention.

What is claimed is:

1. A hot melt glue gun, comprising:
a motor;
a heating section; and
an advancement mechanism, wherein:
the motor is configured to drive the advancement mechanism to advance a solid thermoplastic adhesive rod along an advancement axis towards the heating section,
the advancement mechanism comprises a multi-stage gear transmission comprising a plurality of gears having parallel rotational axes arranged substantially perpendicular to the advancement axis,
the motor has a rotational output shaft carrying a gear that is meshed with a first stage gear of the advancement mechanism, and
the rotational output shaft of the motor is parallel to the parallel rotational axes of the plurality of gears of the multi-stage gear transmission.

2. The hot melt glue gun of claim 1, wherein the advancement mechanism includes one or more rotary advancement members arranged to contact the solid thermoplastic adhesive rod and advance the solid thermoplastic adhesive rod towards the heating section by rotation of the one or more rotary advancement members by the multi-stage gear transmission driven by the motor.

3. The hot melt glue gun of claim 2, wherein each of the one or more rotary advancement members is carried by a gear shaft of the multi-stage gear transmission of the advancement mechanism.

4. The hot melt glue gun of claim 3, wherein each of the one or more rotary advancement members is located on a region of the gear shaft which extends beyond a first side of the multi-stage gear transmission, thereby providing clearance between the solid thermoplastic adhesive rod and the multi-stage gear transmission.

5. The hot melt glue gun of claim 4, wherein the motor is located beyond a second side of the multi-stage gear transmission, opposite to the first side.

6. The hot melt glue gun of claim 1, wherein the rotational output shaft of the motor is substantially surrounded by the plurality of gears of the multi-stage gear transmission, when viewed in a direction along the rotational output shaft of the motor.

7. The hot melt glue gun of claim 1, wherein the plurality of gears of the multi-stage gear transmission have a serpentine arrangement, when viewed in a direction along the rotational output shaft of the motor.

8. The hot melt glue gun of claim 1, further comprising a glue gun housing supporting and at least partly containing the motor, the heating section, and the advancement mechanism.

9. The hot melt glue gun of claim 8, wherein the motor extends at least partly into a handle portion of the glue gun housing.

10. A hot melt glue gun, comprising:
a housing;
a heating section;
an advancement mechanism; and
an output nozzle, the housing supporting the heating section, the advancement mechanism, and the output nozzle, wherein:
the housing carries a drip tray that is extendable and retractable, and
the drip tray is configured to be both translatable and rotatable with respect to the housing to enable the drip tray to be moved with respect to the housing between its extended and retracted positions.

11. The hot melt glue gun of claim 10, wherein the drip tray is mounted on a carrier which is supported by the housing.

12. The hot melt glue gun of claim 11, wherein the drip tray is rotatable with respect to the carrier, thereby to rotate the drip tray with respect to the housing.

13. The hot melt glue gun of claim 11, wherein the carrier includes an opening in which the drip tray is rotatably receivable, and from which the drip tray is rotatably extendable.

14. The hot melt glue gun according to claim 11, wherein the housing includes a recess or slot, and at least part of the carrier is slidably received in the recess or slot such that the carrier is translatable with respect to the housing, thereby to translate the drip tray with respect to the housing.

15. The hot melt glue gun of claim 10, wherein the drip tray is translatable and rotatable in any order.

16. The hot melt glue gun of claim 14, wherein the carrier includes one or more retainers for slidably retaining the carrier in the recess or slot.

17. A hot melt glue gun comprising:
a heating section;
a motor having a rotational output shaft; and
an advancement mechanism configured to advance an adhesive rod toward the heating section, the advancement mechanism including a multi-stage gear transmission,
wherein the multi-stage gear transmission comprises a plurality of gears arranged such that the rotational output shaft of the motor is substantially surrounded by the plurality of gears when viewed in a direction along the rotational output shaft.

18. The hot melt glue gun of claim 17, wherein the plurality of gears have a serpentine arrangement when viewed in the direction along the rotational output shaft.

19. The hot melt glue gun of claim 17, wherein:
the advancement mechanism includes at least one rotary advancement member extending beyond a first side of the multi-stage gear transmission, and
the motor is located beyond an opposite second side of the multi-stage gear transmission.

20. The hot melt glue gun of claim 17, wherein the multi-stage gear transmission includes a pair of meshed final-stage gear wheels configured to rotate at a same speed in opposite directions to drive a pair of rotary advancement members.
